(19) United States
(12) Patent Application Publication
(10) Pub. No.: US 2026/0262011 A1
(43) Pub. Date: Sep. 3, 2026

(54) POSITIONING METHODS AND COMMUNICATION DEVICES

(71) Applicant: Quectel Wireless Solutions Co., Ltd., Shanghai (CN)

(72) Inventor: Zheng ZHAO, Shanghai (CN)

(73) Assignee: Quectel Wireless Solutions Co., Ltd., Shanghai (CN)

(21) Appl. No.: 19/657,427

(22) Filed: Apr. 24, 2026

Related U.S. Application Data
(63) Continuation of application No. PCT/CN2024/078154, filed on Feb. 22, 2024.

(51) Int. Cl. H04W 64/00; H04B 7/06

(52) U.S. Cl. CPC H04W 64/00; H04B 7/0626

(57) ABSTRACT

A method for positioning includes: a first device acquires first information of a first reference point, the first information of the first reference point being used for training a first model, and the first information including position information and/or channel state information between the reference point and a network device; and the first device inputs position information of a second reference point into the first model, so as to obtain channel state information between the second reference point and the network device, the first information of the first reference point and first information of the second reference point being used for training a second model, and the second model being used for positioning of a terminal device.

### CROSS-REFERENCE TO RELATED APPLICATIONS

The present application is a continuation of International Application No. PCT/CN2024/078154, filed on Feb. 22, 2024, the content of which is incorporated herein by reference in its entirety.

### TECHNICAL FIELD

The present disclosure relates to the field of communication technologies, and in particular to a method for positioning and a communication device.

### BACKGROUND

With the continuous advancement of science and technology, methods for positioning terminal devices using models (such as artificial intelligence models) have emerged. Before a terminal is positioned by using an artificial intelligence model, the model needs to be trained by using information of reference points.

A larger quantity of reference points indicates a higher accuracy of the artificial intelligence model, and a higher accuracy of the positioning results obtained using the artificial intelligence model. However, collecting information of more reference points consumes more manpower and material resources, resulting in increasing of the cost of training the artificial intelligence model.

### SUMMARY

Embodiments of the present disclosure provide a method for positioning and a communication device. Aspects involved in the present disclosure are described below.

In a first aspect, embodiments of the present disclosure provide a method for positioning. The method includes: acquiring, by a first device, first information of a first reference point, where the first information of the first reference point is used to train a first model, and the first information includes positional information and/or channel state information between the first reference point and a network device; and inputting, by the first device, positional information of a second reference point into the first model to obtain channel state information between the second reference point and the network device. The first information of the first reference point and first information of the second reference point are used to train a second model, and the second model is used to position a terminal device.

In a second aspect, embodiments of the present disclosure provide a method for positioning. The method includes: receiving, by a network device, a request message transmitted by a first device; and transmitting, by the network device and in response to the request message, a first message to the first device, where the first message includes channel state information between a first reference point and the network device and/or channel state information between a second reference point and the network device. First information of the first reference point is used to train a first model, the first model is used to generate the channel state information between the second reference point and the network device based on the first information of the first reference point and positional information of the second reference point; and the first information of the first reference point and the first information of the second reference point are used to train a second model, and the second model is used to position a terminal device.

In a third aspect, embodiments of the present disclosure provide a communication device. The communication device is a first device, and includes: an acquisition unit, configured to acquire first information of a first reference point, where the first information of the first reference point is used to train a first model, and the first information includes positional information and/or channel state information between the first reference point and a network device; and an input unit, configured to input positional information of a second reference point into the first model to obtain channel state information between the second reference point and the network device. The first information of the first reference point and first information of the second reference point are used to train a second model, and the second model is used to position a terminal device.

In a fourth aspect, embodiments of the present disclosure provide a network device. The network device includes: a receiving unit, configured to receive a request message transmitted by a first device; and a transmitting unit, configured to transmit a first message to the first device in response to the request message, where the first message includes channel state information between a first reference point and the network device and/or channel state information between a second reference point and the network device. First information of the first reference point is used to train a first model, and the first model is used to generate channel state information between the second reference point and the network device based on the first information of the first reference point and positional information of the second reference point. The first information of the first reference point and first information of the second reference point are used to train a second model, and the second model is used to position a terminal device.

In a fifth aspect, embodiments of the present disclosure provide a communication device. The communication device is a first device, including a memory and a processor. The memory is configured to store one or more computer programs, and the processor is configured to call the programs in the memory to cause the communication device to implement part or all of the operations described in the method according to the first aspect.

In a sixth aspect, embodiments of the present disclosure provide a network device, including a processor, a memory, and a transceiver. The memory is configured to store one or more computer programs, and the processor is configured to call the computer programs in the memory to cause the network device to implement part or all of the operations described in the method according to the second aspect.

In a seventh aspect, embodiments of the present disclosure further provide a communication system, including the foregoing terminal device and/or network device. In another possible implementation, the system may further include other devices that interact with the terminal device or the network device in the solutions provided in the embodiments of the present disclosure.

In an eighth aspect, embodiments of the present disclosure further provide a computer-readable storage medium storing a computer program, and the computer program causes a communication device (e.g., a first device or a network device) to implement part or all of the operations described in the method according to the above aspects.

In a ninth aspect, embodiments of the present disclosure further provide a computer program product including a non-transitory computer-readable storage medium storing a computer program, where the computer program is operable to cause a communication device (e.g., a first device or a network device) to implement part or all of the operations in the method according to the above aspects. In some implementations, the computer program product may be a software installation package.

In a tenth aspect, embodiments of the present disclosure provide a chip, including a memory and a processor. The processor is configured to call and run a computer program from the memory to implement part or all of the operations described in the method according to the above aspects.

According to the present disclosure, first information of a second reference point is generated through a first model, and then the second reference point is used to train a second model. Since the first information of the second reference point is generated by the first model, the solution of the present disclosure can reduce the manpower and material resources consumed by manual measurement, thereby facilitating reducing a training cost of the second model.

### BRIEF DESCRIPTION OF THE DRAWINGS

FIG. 1 shows a wireless communication system 100 to which an embodiment of the present disclosure is applied.

FIG. 2 illustrates a neural network model to which an embodiment of the present disclosure is applied.

FIG. 3 illustrates a neural network model to which an embodiment of the present disclosure is applied.

FIG. 4 illustrates a convolutional neural network to which an embodiment of the present disclosure is applied.

FIG. 5 illustrates a long short-term memory (LSTM) model to which an embodiment of the present disclosure is applied.

FIG. 6 is a schematic diagram of collecting first information of a reference point.

FIG. 7 is a schematic flow chart of a method for positioning according to an embodiment of the present disclosure.

FIG. 8 is a schematic diagram of determining first information of a second reference point according to an embodiment of the present disclosure.

FIG. 9 is a schematic flowchart of another method for positioning according to an embodiment of the present disclosure.

FIG. 10 is a schematic diagram of generating a CIR prediction value of a second reference point according to an embodiment of the present disclosure.

FIG. 11 is a schematic block diagram of a communication device according to an embodiment of the present disclosure.

FIG. 12 is a schematic block diagram of a network device according to an embodiment of the present disclosure.

FIG. 13 is a schematic structural diagram of a communication device according to an embodiment of the present disclosure.

### DETAILED DESCRIPTION OF THE EMBODIMENTS

The technical solution of the present disclosure are described below with reference to the accompanying drawings.

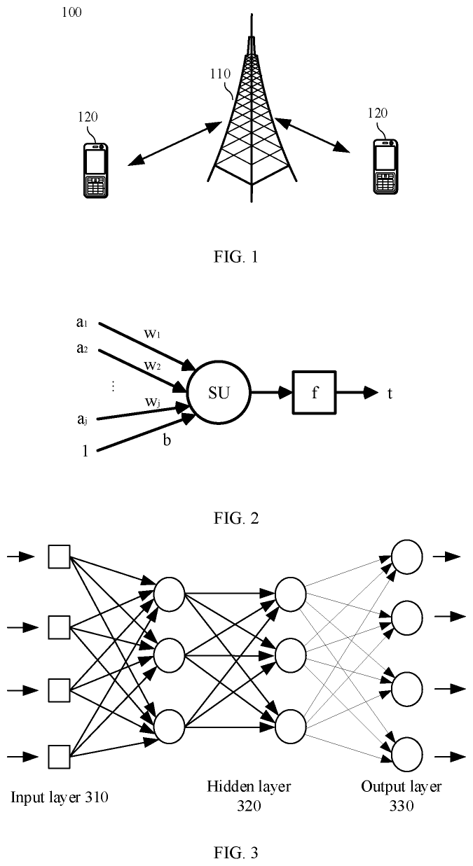

FIG. 1 shows a wireless communication system 100 to which an embodiment of the present disclosure is applied. The wireless communication system 100 may include a network device 110 and a terminal device 120. The network device 110 may be a device in communication with the terminal device 120. The network device 110 may provide communication coverage for a specific geographic area and communicate with a terminal device 120 located within the coverage

FIG. 1 exemplarily illustrates one network device and two terminals. Optionally, the wireless communication system 100 may include multiple network devices, and the coverage of each network device may include other numbers of terminal devices. This is not limited by the embodiments of the present disclosure.

Optionally, the wireless communication system 100 may further include other network entities such as a network controller or a mobility management entity, which are not limited in embodiments of the present disclosure.

It should be understood that the technical solutions of the embodiments of the present disclosure may be applied to various communication systems, for example: the fifth generation (5th generation, 5G) system or new radio (NR) system, long term evolution (LTE) system, LTE frequency division duplex (FDD) system, or LTE time division duplex (TDD) system. The technical solutions provided by the present disclosure may also be applied to future communication systems, such as the sixth generation mobile communication system, satellite communication system, and so on.

The terminal device in embodiments of the present application may also be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may be configured to function as a base station. For example, the UE may function as a scheduling entity, which provides a sidelink signal between UEs in V2X, D2D or the like. For example, a cellular phone and a vehicle communicate with each other by using a sidelink signal. A cellular phone and a smart home device communicate with each other, without relay of a communication signal through a base station.

The network device in embodiments of the present application may be a device configured to communicate with the terminal device. The access network device may also be referred to as a access network device or a radio access network device, for example, the network device may be a base station. The access network device in embodiments of the present application may be a radio access network (radio access network, RAN) node (or device) that connects the terminal device to a wireless network. The base station may broadly cover the following various names, or may be replaced with the following names, such as a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB (master eNB, MeNB), a secondary eNodeB (secondary eNB, SeNB), a multi-standard radio (multi-standard radio, MSR) node, a home base station, a network controller, an access node, a radio node, an access point (access point, AP), a transmission node, a transceiver node, a baseband unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node, and the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that assumes functions of a base station in D2D, vehicle-to-everything (vehicle-to-everything, V2X), and machine-to-machine (machine-to-machine, M2M) communications, a network-side device in a 6G network, a device that assumes functions of a base station in a future communications system, or the like. The base station may support networks with a same access technology or different access technologies. A specific technology and a specific device form used by the network device are not limited in embodiments of the present application.

A base station may be fixed or mobile. For example, a helicopter or unmanned aerial vehicle (UAV) may be configured to act as a mobile base station, where one or more cells may move according to the location of the mobile base station. In other examples, a helicopter or UAV may be configured to communicate with another base station.

In some deployments, the network device in the embodiments of the present disclosure may refer to a CU or a DU, or the network device includes a CU and a DU. A gNB may further include an AAU.

Network devices and terminal devices may be deployed on land, including being deployed indoor or outdoor, handheld or vehicle-mounted; or may be deployed on water; or may be deployed on planes, balloons, or satellites in the air. The embodiments of the present disclosure do not limit the scenarios where network devices and terminal devices are located.

It should be understood that all or part of the functions of the communication device in the present disclosure may also be implemented by software functions running on hardware, or by virtualized functions instantiated on a platform (e.g., a cloud platform).

### Neural Network

In recent years, artificial intelligence research represented by neural networks has achieved significant results in many fields and will play an important role in people's production and life for a long time in the future. A neural network may be understood as a computational model including multiple interconnected neuron nodes, where the connections between nodes represent weighted values from input signals to output signals, commonly referred to as parameters. Each node calculates a weighted sum of different input signals and outputs a result through a specific activation function.

As shown in FIG. 2, the neuron may achieve nonlinear mapping through an activation function. Input of the neuron may be recorded as A, each dimension of the input is denoted as aⱼ, a corresponding parameter is denoted as wⱼ. The neuron together with summation units (SU) enhances or weakens the input. Additionally, the output of the SU may be inputted to the activation function ƒ to obtain the output t, where j takes values of 1, 2, . . . , n.

Common neural networks include convolutional neural network (convolutional neural network, CNN), recurrent neural networks (recurrent neural network, RNN), and deep neural networks (deep neural network, DNN), and so on.

A neural network to which embodiments of the present disclosure is applied will be described below with reference to FIG. 3. The neural network shown in FIG. 3 may be divided into three types based on the positions of different layers: an input layer 310, a hidden layer 320, and an output layer 330. Generally, the first layer is the input layer 310, the last layer is the output layer 330, and all intermediate layers between the first layer and the last layer are hidden layers 320.

The input layer 310 is configured to input data, where the input data may be, for example, a signal received by a receiver. The hidden layer 320 is configured to process the input data, such as decompressing the received signal. The output layer 330 is configured to output the processed data, for example, the decompressed signal.

As shown in FIG. 3, the neural network includes multiple layers, and each layer includes multiple neurons. Neurons between layers may be fully connected or partially connected. For connected neurons, the output of neurons in a previous layer may serve as the input of neurons in a next layer.

With the continuous development of neural network research, deep learning algorithms based on a neural network have been proposed in recent years. By introducing more hidden layers into the neural network, a deep neural network (DNN) is formed. More hidden layers enable the DNN to better characterize complex scenarios in the real world. Theoretically, a model contains more parameters, indicating a higher complexity and a larger “capacity”. That is, the model can perform more complex learning tasks. Such neural network models are widely applied in fields such as pattern recognition, signal processing, optimization combination, and anomaly detection.

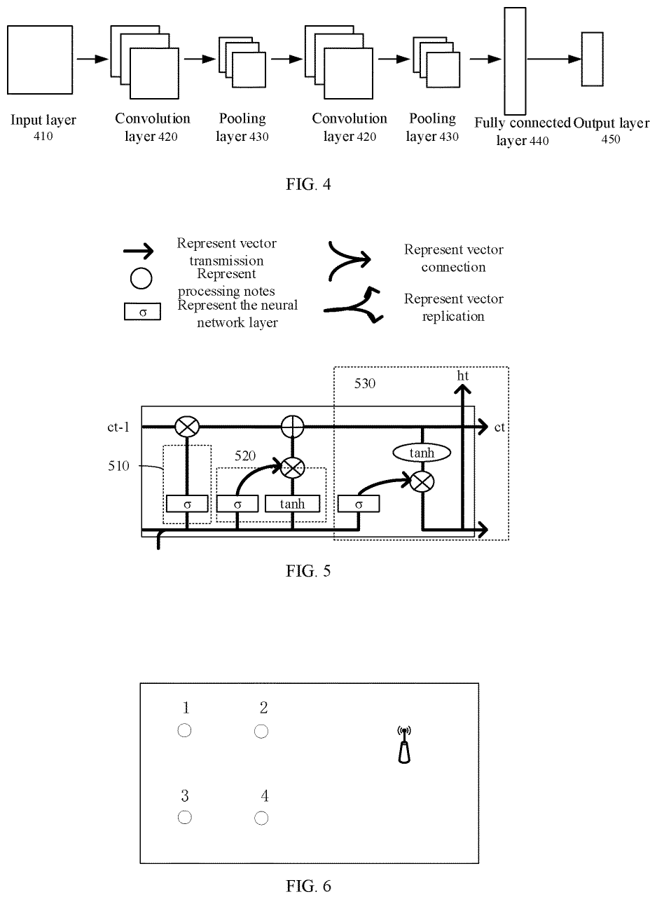

A CNN is a deep neural network with a convolutional structure, as shown in FIG. 4, which may include an input layer 410, a convolution layer 420, a pooling layer 430, a fully connected layer 440, and an output layer 450.

Each convolution layer 420 may include multiple convolutional operators, also referred to as kernels, which function as filters to extract specific information from an input signal. A convolutional operator may be essentially a parameter matrix, which is generally predefined.

The parameter values in these matrices need to be obtained through extensive training in practice. Each parameter matrix formed by the obtained parameter values can extract information from the input signal, thereby facilitating performing accurate prediction by the CNN.

When a CNN has multiple convolutional layers, an initial convolution layer often extracts more general features, also referred to as low-level features. As a depth of the CNN increases, features extracted by subsequent convolutional layers become increasingly complex.

Regarding the pooling layer 430, since it is often necessary to reduce the number of training parameters, pooling layers are often arranged periodically after convolutional layers. For example, as shown in FIG. 4, one convolutional layer may be followed by one pooling layer, or multiple convolutional layers may be followed by one or more pooling layers. In signal processing, the pooling layer is to used to only reduce a spatial size of the extracted information.

After processing is performed by the convolutional layer 420 and the pooling layer 430, the CNN cannot output the required information. As mentioned above, the convolutional layer 420 and pooling layer 430 only extract features and reduce parameters introduced by the input data. However, to generate the final output information (e.g., a bitstream of original information transmitted by the transmitter), the CNN needs to utilize the fully connected layer 440. Generally, the fully connected layer 440 may include multiple hidden layers, and parameters in the hidden layers may be obtained by pre-training by using relevant training data for specific task types. For example, the task type may include decoding data signals received by the receiver or performing channel estimation based on pilot signals received by the receiver.

After processing is performed by the multiple hidden layers in the fully connected layer 440, the output layer 450, which is a last layer of the entire CNN, is configured to output a result. Generally, the output layer 450 is configured with a loss function (e.g., a loss function similar to classification cross-entropy) to calculate a prediction error, or to evaluate a degree of difference between the result output by the CNN model (also called a predicted value) and an ideal result (also called a true value).

To minimize the loss function, the CNN model needs to be trained. In some implementations, the CNN model may be trained by using the backpropagation (BP) algorithm. The BP training process consists of a forward propagation process and a backward propagation process. In forward propagation (as shown in FIG. 4, propagation from 410 to 450 is forward propagation), input data is inputted into the aforementioned layers of the CNN model, subjected to processing layer by layer, and transmitted to the output layer. If the difference between the output result from the output layer and the ideal result is significant, minimizing the loss function is set as an optimization target, and the process switches to backward propagation (as shown in FIG. 4, propagation from 450 to 410 is backward propagation). A partial derivative of the optimization target with respect to each neuron's weight is calculated layer by layer, the calculated partial derivatives form a gradient of the optimization target with respect to a weight vector. This gradient serves as the basis for modifying the model parameters, and the CNN training process proceeds while the parameters are modified. When the aforementioned error reaches an expected value, the CNN training process ends.

It should be noted that the CNN shown in FIG. 4 is merely an example of a convolutional neural network. In specific applications, convolutional neural networks may be implemented as other network models, which are not limited in the embodiments of the present disclosure.

The RNNs are used to process sequence data. In the traditional neural network models (e.g., a CNN model), data is transmitted from the input layer to the hidden layers and then to the output layer. Layers are fully connected, while nodes within each layer are connectionless. However, such ordinary neural networks are ineffective for many problems. For example, to predict a next word in a sentence, previous words need to be used because words in the sentence are not independent of each other. RNNs are called recurrent neural networks because a current output of a sequence is related to previous outputs. Specifically, the network memorizes previous information and applies the information to the calculation of the current output. That is, nodes between hidden layers are connected to each other, and the input of a hidden layer includes not only the output of the input layer but also the output of the hidden layer at a previous time instant. Theoretically, RNNs can process sequence data with any length.

Training an RNN is similar to training a traditional ANN (artificial neural network). The backpropagation (BP) error algorithm is used for both the RNN and the CNN, but there is a difference. when the RNNs are unfolded, parameters W, U, and V are shared, while the traditional neural networks do not share the parameters. Moreover, when the RRN uses the gradient descent algorithm, the output of each step depends not only on a network state of a current step but also on network states of several previous steps. For example, at t=4, backpropagation needs to proceed for three steps, and each of subsequent three steps needs to include respective gradients. This learning algorithm is called backpropagation through time (BPTT).

Both convolutional neural network and the artificial neural network assume that elements are independent of each other, and inputs are independent of outputs (e.g., cats and dogs). However, in the real world, many elements are interconnected. For example, stock prices change over time, or a person says, “I like travelling, and my favorite place is Yunnan. I must go . . . when I get a chance” When filling in the blank, people would all know the answer is “Yunnan,” as we infer it from the context. But it is quite difficult for machines to infer as above. Thus, a recurrent neural network is developed. Its essence is that the recurrent neural network has memory capabilities like humans, so an output of the recurrent neural network depends on both a current input and memory. In short, an RNN reuses a single unit structure repeatedly.

Currently, to address the gradient explosion and vanishing problems of RNN, a long short-term memory (LSTM) model is obtained by modifying the RNN. Referring to FIG. 5, LSTM introduces a new memory cell cₜ (also called a “cell state”) for the linear cyclic information transmission, while outputs information to an external state hₜ of the hidden layer. At each time instant t, cₜ records historical information up to the current time instant. Unlike RNN which only considers recent states, the memory cell determines which states should be retained and which states should be forgotten, thereby overcoming defects on long-term memory of the traditional RNN.

With reference to FIG. 5 again, to realize such state selection, the memory cell introduces a gate control mechanism to control information transmission paths, similar to gates in data circuits—“0” indicates closed, and “1” indicates open. The memory cell includes a forget gate 510, an input gate 520, and an output gate 530. The forget gate is configured to control how much information needs to be forgotten by a previous memory cell cₜ−1, the input gate is configured to control how much information needs to be stored for a current candidate status ĉₜ, and the output gate is configured to control how much information needs to be outputted to the external state hₜ from the current memory cell cₜ.

With the continuous advancement of science and technology and the development of the current era, various fields show vigorous growth, and the demand for positioning services is continuously increasing. Thus, high-precision positioning methods have become one of the current research hotspots. The positioning method in the embodiments of the present disclosure may be applied to both indoor and outdoor positioning.

With the rapid development of neural networks, solutions for positioning terminal devices using models have emerged. For example, the terminal device may be positioned using a combination of two models, where one model provides more reference points for the other model. These two models may include a first model and a second model. The second model may be any one of the neural network models described above. The second model may also be an AI model or an ML model. The second model may be, for example, a CNN or RNN. In some embodiments, the second model may be an LSTM model.

The second model may be trained before being used to position a terminal device. For example, the second model may be trained by using the first information of the reference point. The first information may include positional information of a reference point (or a sampling point) and channel state information between the reference point and the network device. In other words, the second model may establish an association relationship between channel state information and positional information. During training, channel state information may be inputted to the second model, and positional information may be used as label data to train the second model. For example, channel state information between a first reference point and the network device, and channel state information between a second reference point and the network device, may be inputted to the second model; and positional information of the first reference point and positional information of the second reference point are used as label data for training the second model. In subsequent positioning, channel state information measured by the terminal device may be inputted to the second model to obtain the positional information of the terminal device.

Taking FIG. 6 as an example, FIG. 6 shows four reference points. When collecting the first information of the reference point, the terminal device may be placed at different reference points, and positional coordinates and corresponding channel state information of the terminal device at each reference point are recorded. For example, the terminal device is placed at a reference point 1, and the terminal device measures a reference signal transmitted by the network device to obtain channel state information 1; the terminal device is placed at a reference point 2, and the terminal device measures a reference signal transmitted by the network device to obtain channel state information 2; the terminal device is placed at a reference point 3, and the terminal device measures a reference signal transmitted by the network device to obtain channel state information 3; and the terminal device is placed at a reference point 4, and the terminal device measures a reference signal transmitted by the network device to obtain channel state information 4. Positional information of different reference points may be known. The positional information and corresponding channel state information of multiple reference points is inputted to the second model for training the second model.

It should be understood that the larger number of reference points indicates higher accuracy of the second model and higher accuracy of a positioning result obtained using the second model. When the number of reference points is small, the accuracy of the positioning result obtained using the second model is low. For example, when the second model is trained using 256, 128, 64, 16, and 9 reference points respectively, tests show that the second model trained with 256 reference points achieves the highest positioning accuracy. As indicated above, the model-based positioning method has high data volume demands.

Currently, most of the first information of reference points is collected manually. The larger number of reference points indicates a higher labor cost for collecting the first information of the reference points, and consumption of significant time and energy.

Based on this, embodiments of the present disclosure provide a method for positioning. According to the method, first information of a second reference point (or a pseudo reference point) is generated through a first model, and then the first information of the second reference point is used to train a second model. The first information of the second reference point is generated by the first model, thereby reducing the manpower and material resources consumed by manual measurement. Therefore, the solution provided by the embodiments of the present disclosure can reduce the labor cost for collecting reference point information while ensuring the accuracy of the second model.

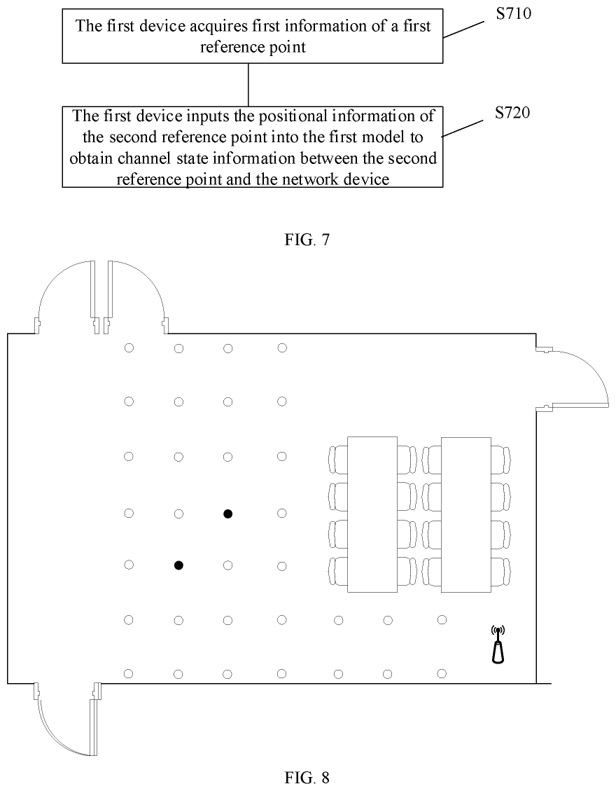

The solution of the embodiment of the present disclosure is described in detail below with reference to FIG. 7.

Referring to FIG. 7, in step S710, a first device acquires first information of a first reference point.

The first device may be any device with computing capability. In some implementations, the first device may be one or more of the following: a positioning server, a location management function (LMF), a serving cell, a positioning reference unit, or a terminal device.

The first reference point may be a terminal device, or a terminal device located at the first reference point. Taking FIG. 8 as an example, dots in FIG. 8 represent reference points. The first device may acquire the first information of the terminal device at the reference point. In some embodiments, a reference point may also be referred to as a sampling point.

The number of the first reference points may be multiple, which is not limited in the embodiments of the present disclosure, as long as the number of first reference points can meet a training requirement of the first model.

The first information may include positional information of the reference point and/or channel state information between the reference point and a network device. The first information of the first reference point may include positional information of the first reference point and/or channel state information between the first reference point and a network device. In some implementations, the first information may include positional information of the reference point and channel state information between the reference point and a network device.

The channel state information between the first reference point and the network device may be measured by the first reference point. The first reference point may measure a reference signal transmitted by the network device to obtain the channel state information. In some implementations, the first reference point may transmit the measured channel state information to the network device. In some implementations, the network device may be a base station.

The channel state information may include, for example, channel impulse response (channel impulse response, CIR) and/or channel frequency response (channel frequency response, CFR).

In some embodiments, first information of the first reference point may be used to train the first model. The first model may be used to establish an association relationship between positional information and the channel state information.

The embodiments of the present disclosure do not limit a manner in which the first device acquires the first information of the first reference point. In some implementations, a network device may transmit the first information of the first reference point to the first device. The first information of the first reference point may be actively transmitted by the network device to the first device or transmitted to the first device after receiving a request from the first device. A detailed description is provided below.

The first information of the first reference point may be used to train the first model. For example, the positional information of the first reference point may be inputted to the first model, and channel state information between the first reference point and the network device may be used as label information to train the first model.

In S720, the first device inputs the positional information of the second reference point into the first model to obtain channel state information between the second reference point and the network device. That is, the input of the first model may include positional information of the second reference point, and the output of the first model may include channel state information between the second reference point and the network device.

The channel state information between the second reference point and the network device may be obtained through the first model, without measuring, by the second reference point, a reference signal transmitted by the network device, thereby reducing labor costs.

In the embodiments of the present disclosure, data information of a small number of reference points may be used as real label information, and data information of other reference points may be predicted through the first model to obtain pseudo-label information, thereby expanding a data volume of reference points. The generated pseudo-label information may be used to supplement actually collected data, thereby enhancing model accuracy, improving positioning precision, and reducing the time cost and labor required for measuring reference point information. Since the solution of the embodiments of the present disclosure does not require installing a large amount of additional hardware devices or modifying existing hardware devices, the solution is easy to popularize and has significant advantages and commercial prospects in high-precision indoor positioning scenarios.

The first model may be any one of the neural network models described above. The first model may be an AI model or an ML model. The first model may be, for example, a CNN or RNN. In some embodiments, the first model may be an LSTM model.

The LSTM model is a recurrent neural network applicable to sequence data processing. The most distinctive feature of the LSTM model is addition of three neural network components: an input gate, a forget gate, and an output gate. By setting the number of hidden layers, the neural network can analyze and organize data information. Based on the above characteristics of the LSTM model, the embodiments of the present disclosure can use the LSTM model to predict the first information of the second reference point.

The position of the second reference point is determined based on the position of the first reference point. As shown in FIG. 8, solid dots represent the second reference points, and hollow dots represent the first reference points.

The second reference point may be a reference point that the user wishes to measure, and the positional information of the second reference point may be determined by the user or by the first device. For example, the first device may determine the positional information of the second reference point based on a first rule.

The positional information of a reference point may be either an absolute position or a relative position, which is not limited in the embodiments of the present disclosure. As an example, in outdoor positioning scenarios, the positional information of a reference point may be an absolute position. The positional information of a reference point may, for example, include longitude and/or latitude information. As another example, in indoor positioning scenarios, the positional information of a reference point may be a relative position. The positional information of a reference point may be position information in a first coordinate system. For instance, the position coordinates of a reference point may be denoted as (x, y).

To improve accuracy of a positioning result, the first model may be trained based on the channel state information between the first reference point and multiple network devices (e.g., multiple base stations) in embodiments of the present disclosure.

For example, the first reference point may connect to base station 1 and measure a reference signal transmitted by the base station 1 to obtain CSI-1; the first reference point may connect to base station 2 and measure a reference signal transmitted by the base station 2 to obtain CSI-2; and so on.

The embodiments of the present disclosure do not limit a measurement process of the channel state information. For example, multiple terminal devices may be placed at multiple reference points respectively (e.g., one terminal device per reference point) and then channel state information between each terminal device and the network device is measured. For another example, a single terminal device may be placed at different reference points, and channel state information between the terminal device at different reference points and the network device is measured.

In some embodiments, the channel state information may include CIR. The CIR may be represented by a matrix. The embodiments of the present disclosure do not limit a sampling length of the CIR matrix. For example, the sampling length of the CIR matrix may be 4096, 2048, or the like. The sampling length of the CIR matrix may be understood as its dimension. To reduce data processing complexity, the first device may perform dimension reduction on the collected CIR matrix and use the CIR matrix subjected to dimension-reducing to train the first model.

In some embodiments, a first device may obtain a first CIR matrix between the first reference point and the network device, and process the first CIR matrix to obtain a second CIR matrix. A dimension of the second CIR matrix is smaller than that of the first CIR matrix. The processing of the first CIR matrix by the first device may also be referred to as dimension reduction processing.

The embodiments of the present disclosure do not limit the dimension reduction method. As an example, the first device may merge multiple rows of elements in the first CIR matrix into a single row, where the merging may include averaging, summation, or the like. For instance, the first device may average multiple rows of elements in the first CIR matrix to obtain one row of elements in the second CIR matrix. As another example, the first device may delete some elements from the first CIR matrix, with remaining elements forming the second CIR matrix. The elements reserved by the first device may be elements of the first M rows, the last M rows, or the middle rows. For example, the first device may acquire the first M rows of the first CIR matrix (i.e., retain only data information of the first M rows) to obtain the second CIR matrix.

In some embodiments, the first CIR matrix has a dimension of 4096 or a sampling length of 4096, and the second CIR matrix has a dimension of 256 or a sampling length of 256.

In some embodiments, due to interference factors such as noise in the measurement process, the first CIR matrix may include some interference information, such as noise. In this case, the first device may filter the first CIR matrix to obtain the second CIR matrix, in other words, the second CIR matrix is the filtered matrix. Filtering the first CIR matrix can reduce the impact of interference (e.g., noise) on the training accuracy of the first model, thereby being beneficial to improve the accuracy of the first model.

The embodiments of the present disclosure do not limit an order of filtering and dimension reduction. As an example, the first device may first perform dimension reduction on the first CIR matrix and then filter the matrix subjected to dimension-reducing to obtain the second CIR matrix. As another example, the first device may first filter the first CIR matrix and then perform dimension reduction on the filtered matrix to obtain the second CIR matrix.

The processing procedure of the first CIR matrix is illustrated below, taking dimension reduction followed by filtering as an example.

The first CIR matrix may be represented by the following formula:

$${H}_{b}^{a} = ( \begin{matrix}{R}_{1} & {I}_{1} \\ {R}_{2} & {I}_{2} \\ ⋮ & ⋮ \\ {R}_{N} & {I}_{N}\end{matrix} )$$

In which,

$${H}_{b}^{a}$$

represents the first matrix, a represents the d^{th} base station in a positioning region, b represents the b^{th} reference point in the positioning region, R represents a real part, I represents an imaginary part, and N represents a sampling length.

One

$${H}_{b}^{a}$$

matrix is obtained between one reference point and one base station.

The first device may truncate the matrix

$${H}_{b}^{a}$$

to obtain the matrix

$${\hat{H}}_{b}^{a} .$$

The matrix

$${\hat{H}}_{b}^{a}$$

may be represented as follows:

$${\hat{H}}_{b}^{a} = ( \begin{matrix}{R}_{1} & {I}_{1} \\ {R}_{2} & {I}_{2} \\ ⋮ & ⋮ \\ {R}_{M} & {I}_{M}\end{matrix} )$$

The first device may filter the matrix

$${\hat{H}}_{b}^{a}$$

to obtain the matrix

$${\overline{H}}_{b}^{a} .$$

The matrix

$${\overline{H}}_{b}^{a}$$

may be represented as follows:

$${\overline{H}}_{b}^{a} = ( \begin{matrix}{R}_{1} & {I}_{1} \\ {R}_{2} & {I}_{2} \\ ⋮ & ⋮ \\ {R}_{M} & {I}_{M}\end{matrix} )$$

The matrix

$${\overline{H}}_{b}^{a}$$

may be the second CIR matrix described above.

The first device may train the first model using the second CIR matrix and the positional information of the first reference point. In some embodiments, the first device may combine the second CIR matrix and the positional information of the first reference point to obtain a labeled dataset. The first device may input label data of each reference point into the first model, and train the first model to obtain the trained first model.

The channel state information between the first reference point and the network device may be actively transmitted to the first device by the network device or may be transmitted to the first device by the network device after receiving a request from the first device. This is not limited in the embodiments of the present disclosure.

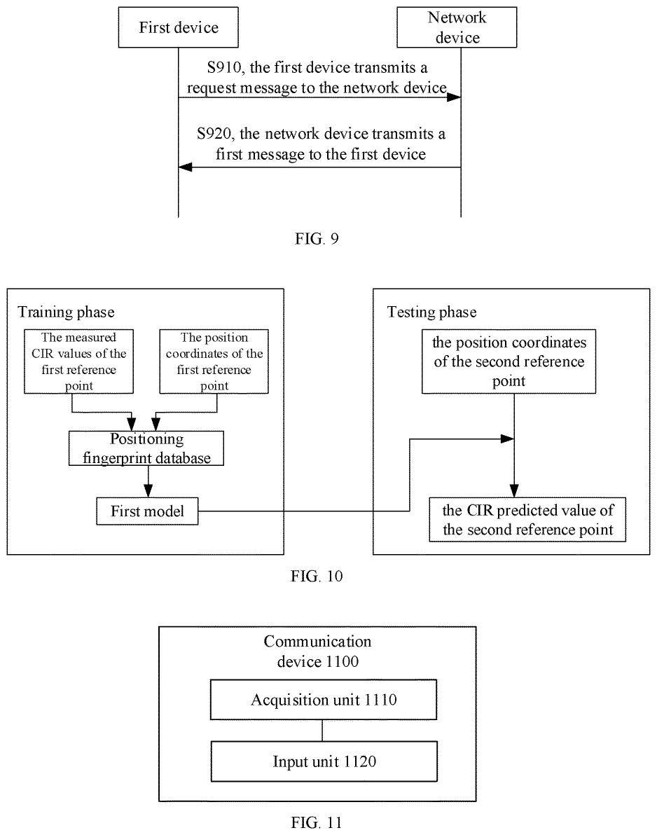

In some implementations, referring to FIG. 9, in S910, the first device may transmit a request message to the network device, where the request message is used to request channel state information between the first reference point and the network device. In S920, the network device transmits a first message to the first device, and the first message includes channel state information between the first reference point and the network device.

The network device may maintain channel state information between the first reference point and the network device. After measuring the channel state information between the first reference point and the network device, the first reference point may transmit the measured channel state information to the network device.

In some embodiments, the request message may further include ID information of the terminal device. After receiving the request message, the network device may transmit the channel state information corresponding to an ID of the terminal device to the first device. According to the ID information of the terminal device, the network device can confirm which channel state information needs to be transmitted.

In some embodiments, the request message may be used to request channel state information corresponding to all terminal devices within coverage of the network device. After receiving the request message, the network device may transmit the channel state information corresponding to all terminal devices in its coverage to the first device. In some implementations, the request message may include first indication information indicating that the first reference point includes all terminal devices within the coverage of the network device. In other implementations, if the request message does not include ID information of the terminal device, the request message is used to request, by default, channel state information corresponding to all terminal devices within the coverage of the network device, thereby reducing the volume of data transmission and saving signaling overhead. After receiving the request message, if the request message carries ID information of the terminal device, the network device may transmit the channel state information corresponding to the ID information of the terminal device to the first device; if the request message does not carry the ID information of the terminal device, the network device may transmit the channel state information corresponding to all terminal devices in the coverage to the first device.

The solution of the embodiments of the present disclosure is described below by examples with reference to FIG. 10. It should be understood that the following description is merely for illustrative purposes to aid understanding, and the embodiments of the present disclosure are not limited to the following examples.

Referring to FIG. 10, the solution of the embodiments of the present disclosure may include a training phase and a testing phase.

During the training phase, some first reference points may be selected, their CIR values are measured, and their position coordinates are recorded. The measured CIR values of the first reference point are combined with the position coordinates of the first reference point to construct a positioning fingerprint database. Data information in the fingerprint database is inputted into the first model, and the first model is trained to obtain the trained first model.

In the testing phase, the position coordinates of the second reference point are inputted to the first model to obtain the CIR predicted value of the second reference point. The CIR predicted value of the second reference point is generated by the first model, thereby effectively expanding the data volume in the positioning fingerprint database.

Taking FIG. 8 as an example, the first reference points are hollow dots, and the second reference points are solid dots. A positioning server may collect CIR data information of the hollow dots and predict CIR data information of the solid dots through the first model.

The technical solution provided by the embodiments of the present disclosure is described in detail below by taking the channel state information being CIR as an example. It should be understood that the following description is merely for illustrative purposes to aid understanding, and the embodiments of the present disclosure are not limited to the following descriptions.

In an area to be positioned, there are A base stations, and B reference points are randomly selected within the area. The B reference points are classified into B1 training points and B2 prediction pints. The terminal device is placed at the B1 training points in sequence, and the CIR matrix

$${H}_{b}^{a}$$

(a=1,2,3, . . . , A; b=1,2,3, . . . , B) between the terminal device at each training point and each base station is measured, and the position coordinates (x_{b}, y_{b}) of the reference point where the terminal device is located are recorded.

The matrix

$${H}_{b}^{a}$$

may be represented as follows:

$${H}_{b}^{a} = ( \begin{matrix}{R}_{1} & {I}_{1} \\ {R}_{2} & {I}_{2} \\ ⋮ & ⋮ \\ {R}_{N} & {I}_{N}\end{matrix} )$$

Each CIR matrix is truncated to obtain the matrix

$${\hat{H}}_{b}^{a} .$$

The matrix

$${\hat{H}}_{b}^{a}$$

may be expressed as follows:

$${\hat{H}}_{b}^{a} = ( \begin{matrix}{R}_{1} & {I}_{1} \\ {R}_{2} & {I}_{2} \\ ⋮ & ⋮ \\ {R}_{M} & {I}_{M}\end{matrix} )$$

Filtering is performed on the matrix

$${\hat{H}}_{b}^{a}$$

to remove interference such as noise, so as to obtain the matrix

$${\overline{H}}_{b}^{a} .$$

The matrix

$${\overline{H}}_{b}^{a}$$

may be expressed as follows:

$${\overline{H}}_{b}^{a} = ( \begin{matrix}{R}_{1} & {I}_{1} \\ {R}_{2} & {I}_{2} \\ ⋮ & ⋮ \\ {R}_{M} & {I}_{M}\end{matrix} )$$

The matrix

$${\overline{H}}_{b}^{a}$$

obtained at each reference point is merged with corresponding coordinate labels (x_{b}, y_{b}) to construct a labeled dataset F.

$$F = ( \begin{matrix}{x}_{b} & {y}_{b} & {\overline{H}}_{b}^{a}\end{matrix} )$$

The datasets F for all reference points are inputted into the first model in sequence and the first model is trained to obtain the trained first model.

The coordinates of the B2 prediction points are inputted into the first model to obtain the CIR information corresponding to the B2 prediction points.

The above describes the method embodiments of the present disclosure in detail with reference to FIGS. 1 to 10. The following describes the apparatus embodiments of the present disclosure in detail with reference to FIGS. 11 to 13. It should be understood that the descriptions of the method embodiments and the apparatus embodiments correspond to each other; therefore, for the parts not described in detail, reference may be made to the foregoing method embodiments.

FIG. 11 is a schematic block diagram of a communication device according to an embodiment of the present disclosure. The communication device 1100 shown in FIG. 11 may be any one of the first devices described above. The communication device 1100 may include an acquisition unit 1110 and an input unit 1120.

The acquisition unit 1110 is configured to acquire first information of a first reference point, the first information of the first reference point is used to train a first model, and the first information includes positional information and/or channel state information between the reference point and a network device.

The input unit 1120 is configured to input positional information of a second reference point into the first model to obtain channel state information between the second reference point and the network device.

The first information of the first reference point and the first information of the second reference point are used to train a second model, and the second model is used to position a terminal device.

In some implementations, the channel state information includes channel impulse response (CIR).

In some implementations, the acquisition unit is configured to: acquire a first CIR matrix between the first reference point and the network device. The communication device further includes a processing unit configured to process the first CIR matrix to obtain a second CIR matrix, where a dimension of the second CIR matrix is smaller than that of the first CIR matrix. The communication device further includes a training unit configured to train the first model based on second CIR matrix and the positional information of the first reference point.

In some implementations, the communication device further includes a transmitting unit configured to transmit a request message to the network device, and the request message is used to request channel state information between the first reference point and the network device. The communication device further includes a receiving unit configured to receive a first message transmitted by the network device, and the first message includes channel state information between the first reference point and the network device and/or channel state information between the second reference point and the network device.

In some implementations, the request message includes ID information of the first reference point.

In some implementations, the request message includes first indication information, where the first indication information is used to indicate that the first reference point includes all terminal devices within coverage of the network device.

In some implementations, the first device is a positioning server.

In some embodiments, the receiving unit and the transmitting unit may be a transceiver 1330, and the acquisition unit 1110 and the input unit 1120 may be a processor 1310. The communication device 1100 may further include a transceiver 1330 and a memory 1320, as specifically shown in FIG. 13.

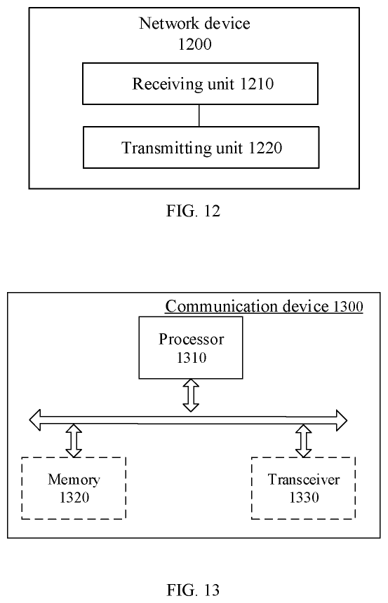

FIG. 12 is a schematic block diagram of a network device according to an embodiment of the present disclosure. The network device 1200 shown in FIG. 12 may be any one of the network devices described above. The network device 1200 may include a receiving unit 1210 and a transmitting unit 1220.

The receiving unit 1210 is configured to receive a request message transmitted by the first device.

The transmitting unit 1220 is configured to, in response to the request message, transmit a first message to the first device, where the first message includes channel state information between the first reference point and the network device and/or channel state information between the second reference point and the network device.

The first information of the first reference point is used to train a first model. The first model is used to generate channel state information between the second reference point and the network device based on the first information of the first reference point and the positional information of the second reference point. The first information of the first reference point and the first information of the second reference point are used to train a second model, and the second model is used to position a terminal device.

In some implementations, the channel state information includes channel impulse response (CIR).

In some implementations, the request message includes ID information of the first reference point.

In some implementations, the request message includes first indication information, where the first indication information is used to indicate that the first reference point includes all terminal devices within coverage of the network device.

In some implementations, the first device is a positioning server.

In some embodiments, the receiving unit 1210 and the transmitting unit 1220 may be a transceiver 1330. The network device 1200 may further include a processor 1310 and a memory 1320, as specifically shown in FIG. 13.

FIG. 13 is a schematic structural diagram of a communication device according to an embodiment of the present disclosure. Dashed lines in FIG. 13 indicate that the unit or module is optional. The communication device 1300 may be configured to implement the methods described in the foregoing method embodiments. The communication device 1300 may be a chip, a first device, or a network device.

The communication device 1300 may include one or more processors 1310. The processor 1310 may support the communication device 1300 to implement the methods described in the foregoing method embodiments. The processor 1310 may be a general-purpose processor or a dedicated processor. For example, the processor may be a central processing unit (central processing unit, CPU). Alternatively, the processor may also be another general-purpose processor, a digital signal processor (digital signal processor, DSP), an application specific integrated circuit (application specific integrated circuit, ASIC), a field-programmable gate array (field-programmable gate array, FPGA), or other programmable logic devices, a discrete gate or transistor logic device, or a discrete hardware component. The general-purpose processor may be a microprocessor, or the processor may also be any conventional processor, etc.

The communication device 1300 may further include one or more memories 1320. Programs are stored in the memory 1320, and the program may be executed by the processor 1310, so that the processor 1310 performs the methods described in the foregoing method embodiments. The memory 1320 may be independent of the processor 1310 or integrated with the processor 1310.

The communication device 1300 may further include a transceiver 1330. The processor 1310 may communicate with other devices or chips through the transceiver 1330. For example, the processor 1310 may transmit and receive data to or from another device or chip through the transceiver 1330.

An embodiment of the present disclosure further provides a computer-readable storage medium for storing a program. The computer-readable storage medium may be applied to the first device or network device provided in the embodiments of the present disclosure, and the program causes a computer to implement the methods performed by the first device or the network device in various embodiments of the present disclosure.

An embodiment of the present disclosure further provides a computer program product. The computer program product includes programs. The computer program product may be applied to the first device or the network device provided in the embodiments of the present disclosure, and the program causes a computer to implement the methods to be performed by the first device or the network device in various embodiments of the present disclosure.

An embodiment of the present disclosure further provides a computer program. The computer program may be applied to the first device or the network device provided in the embodiments of the present disclosure, and the computer program causes a computer to implement the methods to be performed by the first device or the network device in various embodiments of the present disclosure.

It should be understood that the terms “system” and “network” in the present disclosure may be used interchangeably. In addition, the terms used in the present disclosure are only configured to explain the specific embodiments of the present disclosure, and are not intended to limit the present disclosure. The terms “first”, “second”, “third”, “fourth”, and the like in the specification, claims, and drawings of the present disclosure are used to distinguish between different objects, rather than to describe a specific order. In addition, the terms “comprise” and “have” and any variations thereof are intended to cover a non-exclusive inclusion.

In the embodiments of the present disclosure, “indicate” mentioned herein may refer to a direct indication, or may refer to an indirect indication, or may mean that there is an association relationship. For example, A indicating B, may mean that A directly indicates B, for example, B may be obtained by means of A; or may mean that A indirectly indicates B, for example, A indicates C, and B may be obtained by means of C; or may mean that there is an association relationship between A and B.

In the embodiments of the present disclosure, “B corresponding to A” means that B is associated with A, and B may be determined based on A. However, it should also be understood that, determining B based on A does not mean determining B based only on A, but instead B may be determined based on A and/or other information.

In the embodiments of the present disclosure, the term “corresponding” may mean that there is a direct or indirect correspondence between the two, or may mean that there is an association relationship between the two, or may mean that there is a relationship such as indicating and being indicated, or configuring and being configured.

In the embodiments of the present disclosure, “predefined” or “pre-configured” may be implemented by pre-storing corresponding codes, tables, or other forms that may be used to indicate related information in devices (for example, including the terminal device and the network device), and a specific implementation thereof is not limited in the present disclosure. For example, pre-defined may refer to defined in the protocol.

In the embodiments of the present disclosure, the “protocol” may refer to a standard protocol in the communications field, and may include, for example, an LTE protocol, an NR protocol, and a related protocol applied to a future communications system, which is not limited in the present disclosure.

In the embodiments of the present disclosure, the term “and/or” is merely used to describe an association relationship between associated objects, indicating that there may be three relationships. For example, A and/or B may indicate that: only A exists, both A and B exist, and only B exists. In addition, the character “/” herein generally indicates an “or” relationship between the associated objects.

In the embodiments of the present disclosure, sequence numbers of the foregoing processes do not mean execution sequences. The execution sequences of the processes should be determined according to functions and internal logic of the processes, and should not be construed as any limitation on the implementation processes of the embodiments of the present disclosure.

In several embodiments provided in the present disclosure, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected according to an actual need to achieve the objectives of the solutions of the embodiments.

In addition, function units in the embodiments of the present disclosure may be integrated into one processing unit, or each of the units may exist alone physically, or two or more units are integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to the embodiments of the present disclosure are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (digital subscriber line, DSL)) manner or a wireless (such as infrared, radio, and microwave) manner. The computer-readable storage medium may be any usable medium readable by the computer, or a data storage device, such as a server or a data center integrating one or more usable media. The usable medium may be a magnetic medium (for example, a floppy disk, a hard disk, or a magnetic tape), an optical medium (for example, a digital versatile disc (digital versatile disc, DVD)), a semiconductor medium (for example, a solid-state drive (SSD)), or the like.

The foregoing descriptions are merely specific implementations of the present disclosure, but the protection scope of the present disclosure is not limited thereto. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A method for positioning, comprising:
acquiring, by a first device, first information of a first reference point, wherein the first information of the first reference point is used to train a first model, and the first information comprises positional information and/or channel state information between the first reference point and a network device; and
inputting, by the first device, positional information of a second reference point into the first model to obtain channel state information between the second reference point and the network device;
wherein the first information of the first reference point and first information of the second reference point are used to train a second model, and the second model is used to position a terminal device.

2. The method according to claim 1, wherein the channel state information comprises a channel impulse response (CIR), and the acquiring, by the first device, the first information of the first reference point comprises:
acquiring, by the first device, a first CIR matrix between the first reference point and the network device;
wherein the method further comprises:
processing, by the first device, the first CIR matrix to obtain a second CIR matrix, wherein the second CIR matrix has a dimension smaller than a dimension of the first CIR matrix; and
training, by the first device, the first model using the second CIR matrix and positional information of the first reference point.

3. The method according to claim 1, further comprising:
transmitting, by the first device, a request message to the network device, wherein the request message is used to request channel state information between the first reference point and the network device; and
receiving, by first device, a first message transmitted by the network device, wherein the first message comprises the channel state information between the first reference point and the network device and/or the channel state information between the second reference point and the network device.

4. The method according to claim 3, wherein the request message comprises ID information of the first reference point.

5. The method according to claim 3, wherein the request message comprises first indication information, and the first indication information is used to indicate that the first reference point comprises all terminal devices within coverage of the network device.

6. The method according to claim 1, wherein the first device is a positioning server.

7. A method for positioning, comprising:
receiving, by a network device, a request message transmitted by a first device; and
transmitting, by the network device and in response to the request message, a first message to the first device, wherein the first message comprises channel state information between a first reference point and the network device and/or channel state information between a second reference point and the network device,
wherein first information of the first reference point is used to train a first model; the first model is used to generate the channel state information between the second reference point and the network device based on the first information of the first reference point and positional information of the second reference point; the first information of the first reference point and first information of the second reference point are used to train a second model; and the second model is used to position a terminal device.

8. The method according to claim 7, wherein the channel state information comprises a channel impulse response (CIR).

9. The method according to claim 7, wherein the request message comprises ID information of the first reference point.

10. The method according to claim 7, wherein the request message comprises first indication information, and the first indication information is used to indicate that the first reference point comprises all terminal devices within coverage of the network device.

11. The method according to claim 7, wherein the first device is a positioning server.

12. A communication device, wherein the communication device is a first device, and comprises a memory and a processor, wherein the memory is configured to store a computer program, and the processor is configured to execute the computer program stored in the memory to cause the communication device to perform a method comprising:
acquiring first information of a first reference point, wherein the first information of the first reference point is used to train a first model, and the first information comprises positional information and/or channel state information between the first reference point and a network device; and
inputting positional information of a second reference point into the first model to obtain channel state information between the second reference point and the network device,
wherein the first information of the first reference point and first information of the second reference point are used to train a second model, and the second model is used to position a terminal device.

13. The communication device according to claim 12, wherein the channel state information comprises a channel impulse response (CIR), the acquisition unit is configured to acquire a first CIR matrix between the first reference point and the network device;
wherein the communication device is further configured to:
process the first CIR matrix to obtain a second CIR matrix, wherein the second CIR matrix has a dimension smaller than a dimension of the first CIR matrix; and
train the first model using the second CIR matrix and positional information of the first reference point.

14. The communication device according to claim 12, wherein the communication device is further configured to:
transmit a request message to the network device, wherein the request message is used to request channel state information between the first reference point and the network device; and
receive a first message transmitted by the network device, wherein the first message comprises the channel state information between the first reference point and the network device and/or the channel state information between the second reference point and the network device.

15. The communication device according to claim 14, wherein the request message comprises identification (ID) information of the first reference point.

16. The communication device according to claim 14, wherein the request message comprises first indication information, the first indication information is used to indicate that the first reference point comprises all terminal devices within coverage of the network device.

17. The communication device according to claim 12, wherein the first device is a positioning server.

18. A network device, comprising a memory and a processor, wherein the memory is configured to store programs, and the processor is configured to call the program in the memory, to cause the network device to implement the method according to claim 7.

19. A chip, comprising a processor calling a program from a memory, to cause a device installed with the chip to implement the method according to claim 1.

20. A non-transitory computer-readable storage medium storing a program, wherein the program causes a computer to implement the method according to claim 1.
